(19) United States
(12) Patent Application Publication
(10) Pub. No.: US 2006/0241818 A1
(43) Pub. Date: Oct. 26, 2006

(54) In-vehicle display device

(75) Inventor: Hitoshi Kumon, Aichi-gun (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/407,049

(22) Filed: Apr. 20, 2006

(30) Foreign Application Priority Data
Apr. 22, 2005 (JP) 2005-125008

(51) Int. Cl. G05D 1/00

(52) U.S. Cl. 701/1; 701/36

(57) ABSTRACT

In an in-vehicle display device which carried on an automotive vehicle and displays an operation guide of a steering switch, a contact detection unit detects contact of an object with the steering switch. A grasping state detection unit detects whether a vehicle operator is grasping a steering wheel in a predetermined grasping state. A display unit displays the operation guide of the steering switch on a display ahead of the vehicle operator when contact of an object with the steering switches is detected by the contact detection unit and it is detected by the grasping state detection unit that the vehicle operator is grasping the steering wheel in the predetermined grasping state.

### BACKGROUND OF THE INVENTION

1. Field of the Invention

The present invention generally relates to an in-vehicle display device which is carried on an automotive vehicle and displays an operation guide of steering switches. More particularly, the present invention relates to an in-vehicle display device which is configured to prevent unnecessary displaying of the operation guide of the steering switches.

2. Description of the Related Art

Steering switches are known as switches for operating in-vehicle devices. The steering switches are disposed in the spoke part of a steering wheel of an automotive vehicle so that the vehicle operator who grasps the steering wheel can operate the switches with the thumb to perform various operations of in-vehicle devices without separating the hands from the steering wheel during vehicle running.

Conventionally, a steering switch device is proposed wherein each of the steering switches is provided with the electrode for detecting contact of the vehicle operator's finger with the steering switch, to make it unnecessary to change the operator's line of sight from the vehicle forward direction (a distant place) to the steering wheel (or the vicinity thereof) in order to check the position and the kind of each steering switch before operating the steering switch. At the time of contact detection, a steering-switch operation guide which is a diagram showing the arrangement and the kind of the steering switches provided in the steering wheel is displayed on a head-up display. An inverted display indication may be made in the steering-switch operation guide to emphasize the position of the corresponding steering switch currently touched by the vehicle operator so that the vehicle operator may easily recognize, without viewing the steering switches directly, the locations of the steering switch currently touched and the other switches not touched. That is, the steering-switch operation guide will enable the operator to perform blind operation on the steering switch. For example, see Japanese Patent No. 3125367 and Japanese Laid-Open Patent Application No. 2003-175783.

However, in the above-mentioned steering switch device, the operation guide is always displayed when any object in contact with the steering switch is detected. Displaying of the operation guide occurs no matter what object contacts it, without distinguishing its intention and purpose.

For example, FIG. 1 shows a condition in which the vehicle operator's hand has contacted the steering switches accidentally during operation of the steering wheel. In this case, even if the vehicle operator does not intend to operate the steering switch or display the steering-switch operation guide, there is a problem that the vehicle operator's hand, the wrist, the arm, or the cuff of the clothes may contact the steering switches and the operation guide may be displayed. If the operator has no intention of operating the steering switches, displaying of the operation guide on the head-up display will trouble the vehicle operator.

### SUMMARY OF THE INVENTION

An object of the present invention is to provide an improved in-vehicle display device in which the above-mentioned problems are eliminated.

Another object of the present invention is to provide an in-vehicle display device which displays an operation guide of steering switches efficiently and can present unnecessary displaying of the operation guide of the steering switches.

In order to achieve the above-mentioned objects, the present invention provides an in-vehicle display device in-vehicle display device which is carried on a vehicle and displays an operation guide of steering switches, the in-vehicle display device comprising: a contact detection unit detecting contact of an object with the steering switches; a grasping state detection unit detecting whether a vehicle operator is grasping a steering wheel in a predetermined grasping state; and a display unit displaying the operation guide of the steering switches on a display ahead of the vehicle operator when contact of an object with the steering switches is detected by the contact detection unit and it is detected by the grasping state detection unit that the vehicle operator is grasping the steering wheel in the predetermined grasping state.

The above-mentioned in-vehicle display device of the invention may be configured so that the predetermined grasping state of the vehicle operator is a state in which the vehicle operator is capable of operating the steering switches while the vehicle operator is grasping the steering wheel.

The above-mentioned in-vehicle display device of the invention may be configured so that the steering switches comprise right switches provided in a right-hand area of the steering wheel and left switches provided in a left-hand area of the steering wheel, the contact detection unit comprising a right-hand side contact detection unit which detects contact of an object with the right switches, and a left-hand side contact detection unit which detects contact of an object with the left switches, the grasping state detection unit comprising a right-hand grasping state detection unit which detects whether a vehicle operator's right hand is grasping the steering wheel in the predetermined grasping state, and a left-hand grasping state detection unit which detects whether a vehicle operator's left hand is grasping the steering wheel in the predetermined grasping state, and the display unit displaying the operation guide of the steering switches on the display ahead of the vehicle operator when contact of an object with the right switches is detected by the right-hand side contact detection unit and it is detected by the right-hand grasping state detection unit that the vehicle operator's right hand is grasping the steering wheel in the predetermined grasping state, or when contact of an object with the left switches is detected by the left-hand side contact detection unit and it is detected by the left-hand side grasping state detection unit that the vehicle operator's left hand is grasping the steering wheel in the predetermined grasping state.

The above-mentioned in-vehicle display device of the invention may be configured so that operation of the steering switches is permitted regardless of whether the operation guide of the steering switches is displayed by the display unit.

The above-mentioned in-vehicle display device of the invention may be configured so that the display unit functions as a head-up display which projects a display image indicating the operation guide of the steering switches onto a windshield of the vehicle ahead of the vehicle operator.

Moreover, in order to achieve the above-mentioned objects, the present invention provides an in-vehicle display device in-vehicle display device which is carried on a vehicle and displays an operation guide of steering switches, the in-vehicle display device comprising: a grasping state detection unit detecting whether a vehicle operator is grasping a steering wheel in a predetermined grasping state; and a switch operation permission unit permitting operation of the steering switches when it is detected by the grasping state detection unit that the vehicle operator is grasping the steering wheel in the predetermined grasping state.

The above-mentioned in-vehicle display device of the invention may be configured so that the predetermined grasping state of the vehicle operator is a state in which the vehicle operator is capable of operating the steering switches while the vehicle operator is grasping the steering wheel.

The above-mentioned in-vehicle display device of the invention may be configured so that the steering switches comprise right switches provided in a right-hand area of the steering wheel and left switches provided in a left-hand area of the steering wheel, the grasping state detection unit comprising a right-hand grasping state detection unit which detects whether a vehicle operator's right hand is grasping the steering wheel in the predetermined grasping state, and a left-hand grasping state detection unit which detects whether a vehicle operator's left hand is grasping the steering wheel in the predetermined grasping state, and the switch operation permission unit permitting operation of the right switches when it is detected by the right-hand grasping state detection unit that the vehicle operator's right hand is grasping the steering wheel in the predetermined grasping state, and permitting operation of the left switches when it is detected by the left-hand grasping state detection unit that the vehicle operator's left hand is grasping the steering wheel in the predetermined grasping state.

According to the present invention, it is possible to provide an in-vehicle display device which displays the operation guide of the steering switches efficiently and can prevent unnecessary displaying of the operation guide of the steering switches.

### BRIEF DESCRIPTION OF THE DRAWINGS

Other objects, features and advantages of the present invention will be apparent from the following detailed description when read in conjunction with the accompanying drawings.

FIG. 1 a diagram showing a condition in which the vehicle operator's hand has contacted the steering switches accidentally during operation of the steering wheel.

FIG. 2 is a diagram showing the composition of a steering wheel and steering switches provided in the steering wheel.

FIG. 3 is a block diagram showing the composition of a steering-switch display device in an embodiment of the invention.

FIG. 4 is a diagram for explaining a predetermined case in which the steering-switch operation guide is displayed by a display unit in the steering-switch display device of the present embodiment.

FIG. 5 is a diagram showing a condition in which the vehicle operator touches the steering switches when the vehicle operator is not in a predetermined grasping state.

FIG. 6 is a diagram showing an example of an image of the steering-switch operation guide which is displayed by the display unit in the steering-switch display device of the present embodiment.

FIG. 7 is a diagram showing an example of an image of the steering-switch operation guide wherein an operation result is further displayed in the operation guide displayed by the display unit in the steering-switch display device of the present embodiment.

FIG. 8 is a flowchart for explaining a control procedure performed by the steering-switch display device in an embodiment of the invention.

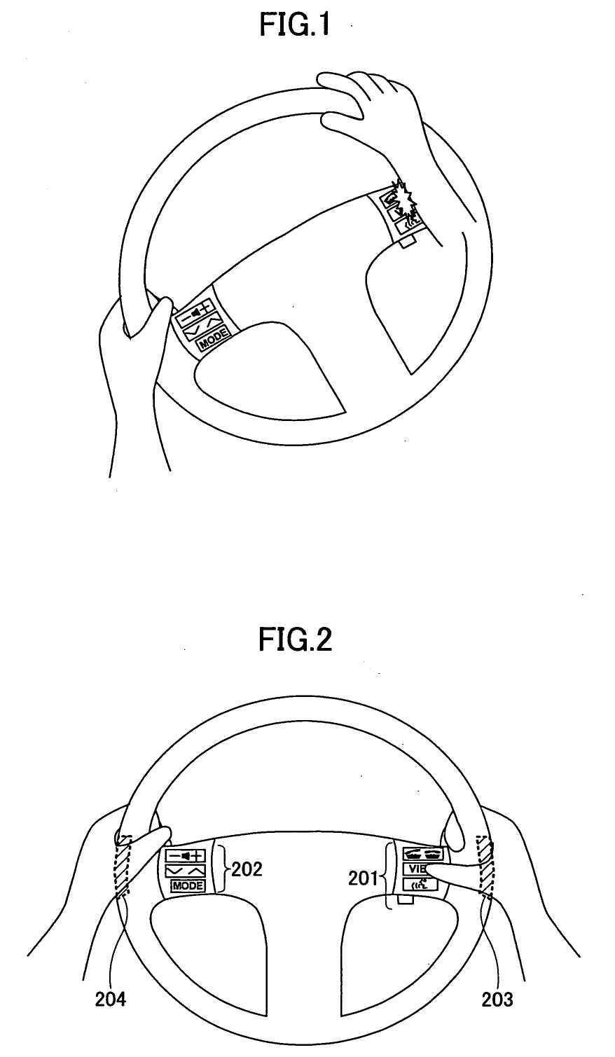

### DETAILED DESCRIPTION OF PREFERRED EMBODIMENTS

A description will now be provided of an embodiment of the invention with reference to the accompanying drawings.

In the following, the composition and operation of the steering switches provided in the spoke part of a steering wheel to perform various operations of in-vehicle devices are known to a person skilled in the art, and a description thereof will be omitted.

The steering-switch display device in an embodiment of the invention will be explained with reference to FIG. 2 to FIG. 8.

FIG. 2 shows the composition of a steering wheel and steering switches provided in the spoke part of the steering wheel.

In the example shown in FIG. 2, the steering switches include the right switches 201 which are disposed on the right-hand spoke part of the steering wheel and intended to be operated with the right hand of the vehicle operator who grasps the steering wheel, and the left switches 202 which are disposed on the left-hand spoke part of the steering wheel and intended to be operated with the left hand of the operator who grasps the steering wheel.

As shown in FIG. 2, the steering switches are arranged in such a position that they can be operated with the thumb of the vehicle operator when the operator grasps the steering wheel in a predetermined position. Conversely, it can be said that if the right hand and the left hand of the vehicle operator are in the grasping position where the operator can operate the steering switches with the thumb it is a desirable grasping position.

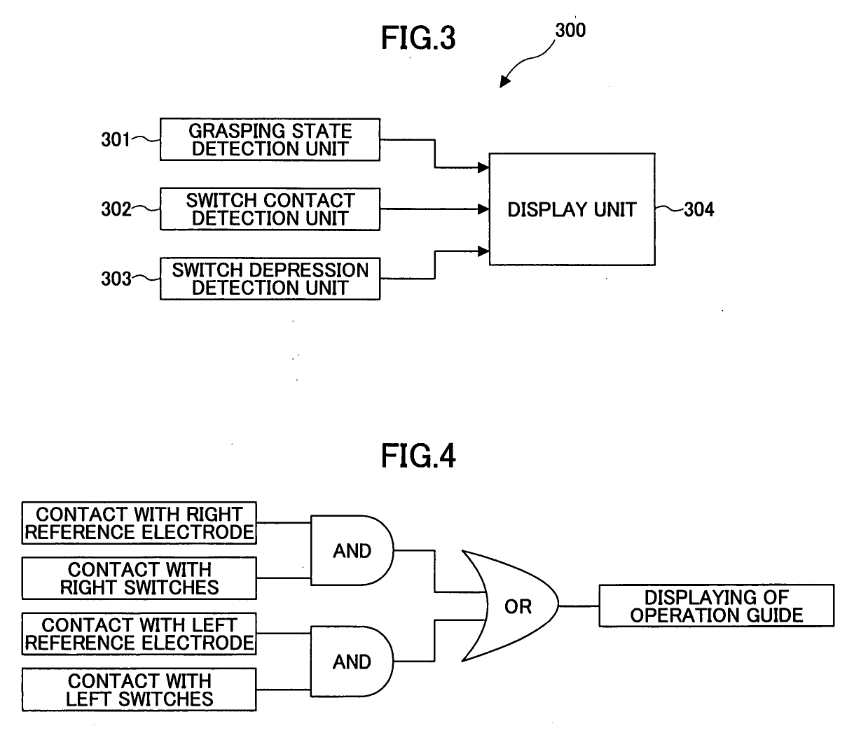

The in-vehicle display device of this embodiment is provided to display the operation guide of such steering switches. The composition of an in-vehicle display device in an embodiment of the invention will be explained with reference to FIG. 3.

FIG. 3 shows the composition of the in-vehicle display device 300 in an embodiment of the invention.

As shown in FIG. 3, the in-vehicle display device 300 comprises a grasping state detection unit 301 which detects whether the vehicle operator is grasping the steering wheel in the predetermined grasping state mentioned above. In this embodiment, the grasping state detection unit 301 includes a right reference electrode 203 which is disposed on the ring portion of the steering wheel at a location where the vehicle operator's right hand certainly contacts the reference electrode 203 when the operator grasped the steering wheel in the predetermined grasping state, as shown in FIG. 2.

Moreover, the grasping state detection unit 301 includes a left reference electrode 204 which is disposed on the ring portion of the steering wheel at a location where the vehicle operator's left hand certainly contacts the reference electrode 204 when the operator grasps the steering wheel in the predetermined grasping state, as shown in FIG. 2.

In the in-vehicle display device 300, both the reference electrodes 203 and 204 are provided to realize the function of electrostatic-capacity type contact detection. In this embodiment, when contact with the right reference electrode 203 of the grasping state detection unit 301 is detected, it is determined that the operator's right hand is grasping the steering wheel in the predetermined grasping state. Similarly, when contact with the left reference electrode 204 is detected, it is determined that the operator's left hand is grasping the steering wheel in the predetermined grasping state.

The in-vehicle display device 300 further comprises a switch contact detection unit 302 which detects contact of an object with the steering switches. In this embodiment, the switch contact detection unit 302 includes a right switch contact detection unit (not shown) which is provided in the right switches 201 to detect contact of an object with the right switches 201, and a left switch contact detection unit (not shown) which is provided in the left switches 202 to detect contact of an object with the left switches 202. In this embodiment, both the right and left switch contact detection units are also provided to realize the function of electrostatic-capacity type contact detection.

The in-vehicle display device 300 further comprises a switch depression detection unit 303 which detects whether one of the steering switches is depressed. When depression of one of the steering switches is detected, a predetermined operation of a corresponding one of a plurality of in-vehicle devices (not shown) which corresponds to the depressed steering switch is performed.

The in-vehicle display device 300 further comprises a display unit 304 which functions as a head-up display that projects a display image indicating the operation guide of the steering switches, onto the front windshield of the vehicle ahead of the vehicle operator.

The display unit 304 is provided to display the operation guide of the steering switches, when contact of an object with the steering switches is detected by the switch contact detection unit 302.

However, the display unit 304 in this embodiment is configured to display the operation guide only in a predetermined case, and in a case in which one of the steering switches is accidentally touched by the operator's hand or finger with no intention of the operator who is operating the steering switches, the operation guide may not be displayed by the display unit 304.

FIG. 4 is a logic diagram for explaining a predetermined case in which the operation guide of the steering switches is displayed by the display unit 304 in the steering-switch display device of the present embodiment.

As shown in FIG. 4, the display unit 304 in this embodiment is configured so that, when contact with the right reference electrode 203 is detected by the grasping state detection unit 301 and contact with the right switches 201 is detected by the switch contact detection unit 302, it is determined that the vehicle operator who is grasping the steering wheel in the predetermined grasping state with the right hand as shown in FIG. 2 is going to operate the steering switch with the right hand (or the thumb). Then, in such a case, the display unit 304 is allowed to display the operation guide of the steering switches.

Moreover, the display unit 304 in this embodiment is configured so that, when contact with the left reference electrode 204 is detected by the grasping state detection unit 301 and contact with the left switches 202 is detected by the switch contact detection unit 302, it is determined that the vehicle operator who is grasping the steering wheel in the predetermined grasping state with the left hand as shown in FIG. 2 is going to operate the steering switch with the left hand (or the thumb). Then, in such a case, the display unit 304 is allowed to display the operation guide of the steering switches.

Thereby, the vehicle operator can view the operation guide on the head-up display, while grasping the steering wheel firmly and looking at the front view of the vehicle.

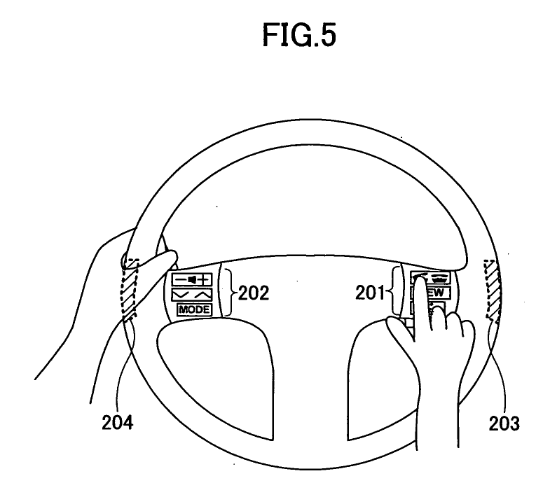

On the other hand, FIG. 5 shows a condition in which the vehicle operator touches the steering switches when the vehicle operator is not in the predetermined grasping state.

According to the above-mentioned embodiment, the operation guide of the steering switches will not be displayed on the head-up display when contact with the steering switches is detected but the vehicle operator is not in the predetermined grasping state as in the condition of FIG. 5. In such a condition, although the vehicle operator intends to perform the switch operation, the operation guide of the steering switches will not be displayed.

However, in the condition of FIG. 5, the vehicle operator views the steering switches directly and performs the switch selection or operation of the steering switch concerned. It can be assumed that any significant problem does not arise to the vehicle operator even if the operation guide is not displayed on the front windshield of the vehicle.

On the contrary, since the operation guide is not displayed unless the vehicle operator is grasping the ring portion of the steering wheel and contacts the steering switch on the same side as shown in FIG. 2, the vehicle operator who desires to use the operation guide will be naturally guided to the predetermined grasping state as shown and FIG. 2.

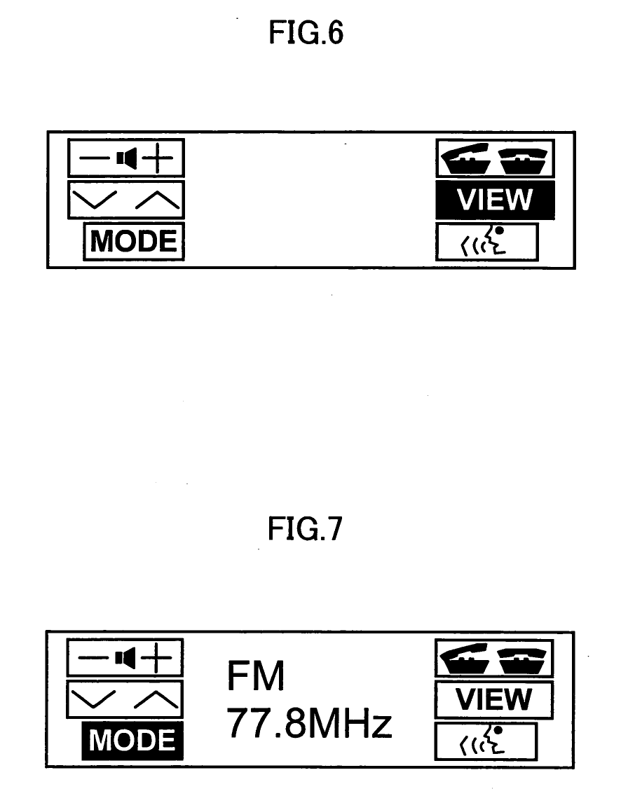

FIG. 6 shows an example of an image of the steering-switch operation guide which is displayed by the display unit 304 in such a limited condition.

In this embodiment, the image of the steering-switch operation guide displayed is provided such that the pattern of each of diagramed buttons of the switches and the arrangement thereof within the corresponding region are essentially the same as the pattern of each of the actual steering switches and the arrangement thereof as shown in FIG. 6. And an inverted-state display indication may be used for the steering switch which is currently touched by the vehicle operator in the image of the steering-switch operation guide so that the operator can easily recognize which of the steering switches is now being touched. Thereby, the vehicle operator can grasp the kind and position of each switch intuitively and visually, and can arrive at the location of a desired steering switch by touching it.

Moreover, when depression of one of the steering switches is detected by the switch depression detection unit 303, the display unit 304 is caused to display an operation result of the switch depression further in the steering-switch operation guide.

FIG. 7 shows an example of an image of the steering-switch operation guide wherein an operation result is further displayed in the operation guide displayed by the display unit 304 in the present embodiment.

In the example of the image shown in FIG. 7, the operation result, which indicates that the mode selection button of the car audio system is depressed and the frequency of the car radio is tuned to FM77.8 MHz, is further displayed in the operation guide displayed by the display unit 304.

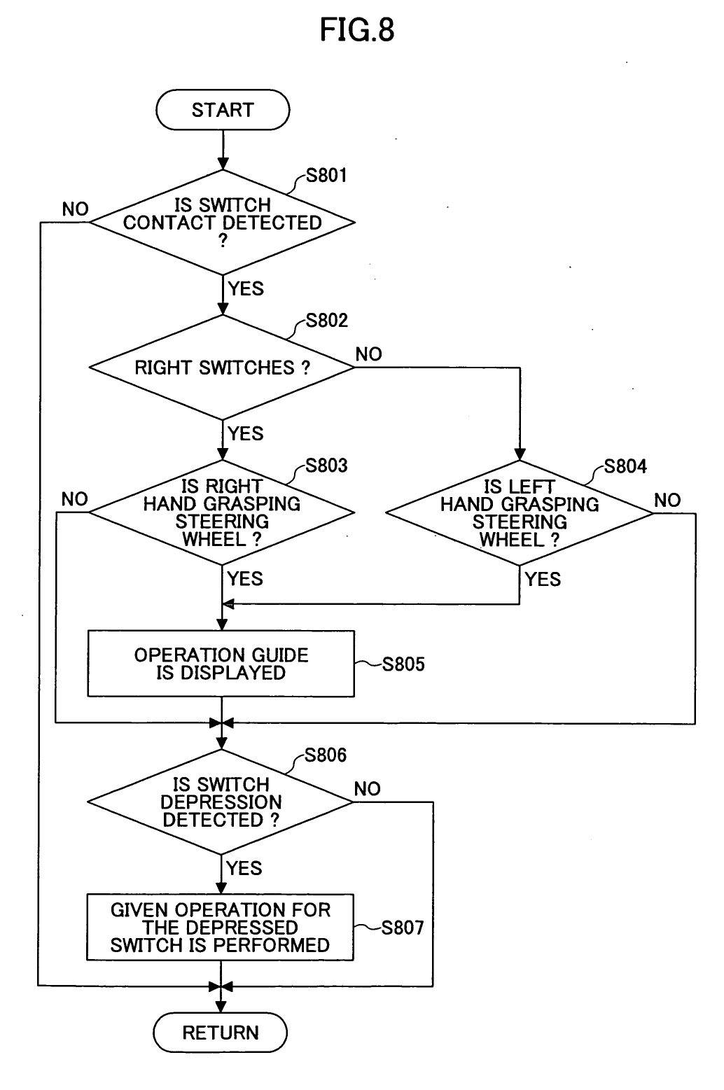

Next, FIG. 8 is a flowchart for explaining the control processing which is performed by the in-vehicle display device 300 in an embodiment of the invention.

Upon start of the control processing of FIG. 8, it is determined whether contact with one of the steering switches is detected by the switch contact detection unit 302 (S801).

When contact with the steering switch is not detected (NO of S801), the processing of FIG. 8 is terminated without performing any special processing.

When contact with the steering switch is detected (YES of S801), it is determined whether the steering switch with which contact is detected is one of the right switches 201 (S802).

As previously described with reference to FIG. 2, the steering switches are constituted by the right switches 201 and the left switches 202. Therefore, if the steering switch with which contact is detected is not one of the right switches 201, it is determined that he steering switch with which contact is detected is one of the left switches 202.

When the steering switch with which contact is detected is one of the right switches 201 (YES of S802), it is determined whether contact with the right reference electrode 203 is detected by the grasping state detection unit 301 (S803). Namely, it is determined in this step S803 whether the vehicle operator's right hand is grasping the steering wheel in the predetermined grasping state as shown in FIG. 2.

When contact with the right reference electrode 203 is detected by the grasping state detection unit 301 (or when the vehicle operator's right hand is determined as being grasping the steering wheel in the predetermined position) (YES of S803), the steering-switch operation guide is displayed by using the head-up display function of the display unit 304 (S805).

As shown in FIG. 6, the operation guide displayed in this step S805 contains not only the buttons indicating the right switches 201 but also the buttons indicating the left switches 202, so that the vehicle operator can grasp immediately the kinds and locations of the steering switches included in both the right and left switches 201 and 202.

On the other hand, when contact with the right reference electrode 203 is not detected by the grasping state detection unit 301 (or when the vehicle operator's right hand is determined as not being grasping the steering wheel in the predetermined grasping state) (NO of S803), the above step S805 is skipped and the display unit 304 does not display the operation guide.

When the steering switch with which contact is detected is one of the left switches 202 (NO of S802), it is determined whether contact with the left reference electrode 204 is detected by the grasping state detection unit 301 (S804). Namely, it is determined in this step S804 whether the vehicle operator's left hand is grasping the steering wheel in the predetermined grasping state as shown in FIG. 2.

When contact with the left reference electrode 204 is detected by grasping state detection unit 301 (or when the vehicle operator's left hand is determined as being grasping the steering wheel in the predetermined grasping state) (YES of S804), the operation guide is displayed by using the head-up display function of the display unit 304 (S805).

Similarly, as shown in FIG. 6, the operation guide displayed in the step S805 contains not only the buttons indicating the left switches 202 but also the buttons indicating the right switches 201, so that the vehicle operator can grasp immediately the kinds and locations of the steering switches included in both the right and left switches 201 and 202.

On the other hand, when contact with the left reference electrode 204 is not detected by the grasping state detection unit 301 (or when the vehicle operator's left hand is determined as not being grasping the steering wheel in the predetermined grasping state (NO of S804), the above step S805 is skipped and the display unit 304 does not display the operation guide.

After the operation guide is displayed at the step S805 or when the result of the determination at the step S803 or S804 is negative, it is determined whether depression of one of the steering switches is detected by the switch depression detection unit 303 (S806).

When depression of one of the steering switches is detected by the switch depression detection unit 303 (YES of S806), a given operation of the in-vehicle device (e.g., the car audio system) corresponding to the depressed steering switch is performed (S807). If the steering-switch operation guide is already displayed, the operation result is further displayed in the operation guide as shown in FIG. 7. The vehicle operator is notified of the operation result indicated in the operation guide.

When depression of any of the steering switches is not detected by the switch depression detection unit 303 over a predetermined time (NO of S806), no special operation is performed and the processing of FIG. 8 is terminated.

The display unit 304 in this embodiment may be configured so that the displaying of the operation guide is automatically turned off after a fixed delay time by using an automatic lighting off function may be carried out, in order to prevent flicking (or chattering) during switch selection.

As described above, according to this embodiment, if one of the steering switches is touched by the finger of the vehicle operator, the steering-switch operation guide is displayed by using the head-up display function of the display unit 304. This enables the vehicle operator to perform the blind operation of the steering switches.

When the vehicle operator does not grasp the steering wheel in the predetermined grasping state, it is determined that the operator does not intend to display the steering switch operation guide, and the operation guide is not displayed in such a case. For this reason, unnecessary displaying of the operation guide which may occur due to contact the cuff of the vehicle operator's clothes with the steering switch or the like is prevented, and giving the vehicle operator troublesomeness is avoided.

According to this embodiment, the steering switches are classified into the right switches and the left switches, and the reference electrodes for detecting whether the vehicle operator is grasping the ring portion of the steering wheel in the predetermined grasping state are provided on the right side and left side of the steering wheel independently of each other. When it is detected that the side where contact with the steering switch is detected matches the side of the steering wheel the vehicle operator is grasping the ring portion of the steering wheel, the steering-switch operation guide is displayed. The operation guide can be displayed even if it is the case where the vehicle operator is grasping the steering wheel with the single hand or where the vehicle operator is going to perform another operation (for example, gearshift operation etc.).

In addition, according to this embodiment, when contact with the steering switch, regardless of whether it is on the right side or the left side is detected as being a trigger of displaying the operation guide, the operation guide being displayed contains both the left switches and the right switches. In either of the case where one of the right switches is touched or the case where one of the left switches is touched, the vehicle operator can easily recognize where the desired switch is, by viewing the operation guide containing both the left switches and the right switches being displayed.

In addition, according to this embodiment, the vehicle operator who feels the displaying of the operation guide convenient will naturally grasp the steering wheel in the predetermined grasping state so that the operation guide may be displayed. Consequently, the vehicle operator is encouraged to grasp the steering wheel in the safe grasping state that is predetermined at the design stage, and the safety of the vehicle when the steering switch is operated by the vehicle operator can be improved.

Alternatively, the above-mentioned embodiment may be modified so that the operation guide being displayed contains one of the left switches and the right switches corresponding to the side where contact with the steering switch is detected as being a trigger of displaying the operation guide. However, as described above, it is preferred that the operation guide containing both the right and left steering switches is displayed when contact with the steering switch, regardless of whether it is on the right side or the left side is detected as in the above-mentioned embodiment.

Exceptionally when a certain steering switch is disposed in the position, such as in the middle of the spoke part of the steering wheel, where the vehicle operator who is grasping the steering wheel cannot contact it, the in-vehicle display device of the above-mentioned embodiment may be modified so that the operation guide is displayed when contact with the steering switch concerned is detected, even if contact with the reference electrode 203 or 204 is not detected.

In the above-mentioned embodiment, the steering-switch operation guide is displayed by using the head-up display function. However, the present invention is not limited to this embodiment. Alternatively, the operation guide may be displayed on a different display, and further it may be displayed in a different direction other than the front direction ahead of the vehicle operator. However, it is clear that the composition of the above-mentioned embodiment is most suitable from a viewpoint of enabling the vehicle operator to view the operation guide display image with a minimum movement of the vehicle operator's line of sight from the state where the vehicle operator is looking at the vehicle front.

In the above-mentioned embodiment, when the vehicle operator does not take the predetermined steering grasping state to grasp the steering wheel, even if contact of the operator's hand with one of the steering switches is detected, the operation guide is not displayed. However, the present invention is not limited to this embodiment. Alternatively, the in-vehicle display device of the invention may be configured so that, when the predetermined steering grasping state is not taken by the vehicle operator, the operator's input operation (input) of the steering switch is not received by the in-vehicle display device.

In such alternative embodiment, it is preferred that the right hand operation and the left hand operation are distinguished as in the above-mentioned embodiment. Namely, in such alternative embodiment, when contact with the right reference electrode is detected and the right hand is determined as being in the predetermined steering grasping state, operation of the right switches is permitted, and when contact with the left reference electrode is detected and the left hand is determined as being in the predetermined steering grasping state, operation of the left switches is permitted.

The present invention is applicable to a steering-switch display device which is carried on an automotive vehicle and displays an operation guide of steering switches. There are no requirements for the appearance, weight, size and running performance of the vehicle on which the in-vehicle display device of the invention is carried.

The present invention is not limited to the above-described embodiments, and variations and modifications may be made without departing from the scope of the invention.

Further, the present application is based upon and claims the benefit of priority of Japanese patent application No. 2005-125008, filed on Apr. 22, 2005, the entire contents of which are incorporated herein by reference.

What is claimed is:

1. An in-vehicle display device which is carried on a vehicle and displays an operation guide of steering switches, comprising:
a contact detection unit detecting contact of an object with the steering switches;
a grasping state detection unit detecting whether a vehicle operator is grasping a steering wheel in a predetermined grasping state; and
a display unit displaying the operation guide of the steering switches on a display ahead of the vehicle operator when contact of an object with the steering switches is detected by the contact detection unit and it is detected by the grasping state detection unit that the vehicle operator is grasping the steering wheel in the predetermined grasping state.

2. The in-vehicle display device according to claim 1 wherein the predetermined grasping state of the vehicle operator is a state in which the vehicle operator is capable of operating the steering switches while the vehicle operator is grasping the steering wheel.

3. The in-vehicle display device according to claim 2 wherein the steering switches comprise right switches provided in a right-hand area of the steering wheel and left switches provided in a left-hand area of the steering wheel,
the contact detection unit comprising a right-hand side contact detection unit which detects contact of an object with the right switches, and a left-hand side contact detection unit which detects contact of an object with the left switches,
the grasping state detection unit comprising a right-hand grasping state detection unit which detects whether a vehicle operator's right hand is grasping the steering wheel in the predetermined grasping state, and a left-hand grasping state detection unit which detects whether a vehicle operator's left hand is grasping the steering wheel in the predetermined grasping state, and
the display unit displaying the operation guide of the steering switches on the display ahead of the vehicle operator when contact of an object with the right switches is detected by the right-hand side contact detection unit and it is detected by the right-hand grasping state detection unit that the vehicle operator's right hand is grasping the steering wheel in the predetermined grasping state, or when contact of an object with the left switches is detected by the left-hand side contact detection unit and it is detected by the left-hand side grasping state detection unit that the vehicle operator's left hand is grasping the steering wheel in the predetermined grasping state.

4. The in-vehicle display device according to claim 1 wherein operation of the steering switches is permitted regardless of whether the operation guide of the steering switches is displayed by the display unit.

5. The in-vehicle display device according to claim 1 wherein the display unit functions as a head-up display which projects a display image indicating the operation guide of the steering switches onto a windshield of the vehicle ahead of the vehicle operator.

6. An in-vehicle display device which is carried on a vehicle and displays an operation guide of steering switches, comprising:
a grasping state detection unit detecting whether a vehicle operator is grasping a steering wheel in a predetermined grasping state; and
a switch operation permission unit permitting operation of the steering switches when it is detected by the grasping state detection unit that the vehicle operator is grasping the steering wheel in the predetermined grasping state.

7. The in-vehicle display device according to claim 6 wherein the predetermined grasping state of the vehicle operator is a state in which the vehicle operator is capable of operating the steering switches while the vehicle operator is grasping the steering wheel.

8. The in-vehicle display device according to claim 7 wherein the steering switches comprise right switches provided in a right-hand area of the steering wheel and left switches provided in a left-hand area of the steering wheel,
the grasping state detection unit comprising a right-hand grasping state detection unit which detects whether a vehicle operator's right hand is grasping the steering wheel in the predetermined grasping state, and a left-hand grasping state detection unit which detects whether a vehicle operator's left hand is grasping the steering wheel in the predetermined grasping state, and
the switch operation permission unit permitting operation of the right switches when it is detected by the right-hand grasping state detection unit that the vehicle operator's right hand is grasping the steering wheel in the predetermined grasping state, and permitting operation of the left switches when it is detected by the left-hand grasping state detection unit that the vehicle operator's left hand is grasping the steering wheel in the predetermined grasping state.
